(19) United States
(12) Patent Application Publication
(10) Pub. No.: US 2026/0111938 A1
(43) Pub. Date: Apr. 23, 2026

(54) GENERATING AND TESTING VARIANTS FOR TARGET ITEMS USING MACHINE-LEARNING MODELS

(71) Applicant: Maplebear Inc., San Francisco, CA (US)

(72) Inventors: Brent Scheibelhut, Toronto (CA); Charles Wesley, San Diego, CA (US)

(21) Appl. No.: 18/924,857

(22) Filed: Oct. 23, 2024

(51) Int. Cl. G06Q 30/0601; G06F 40/20; G06Q 30/0203

(52) U.S. Cl. CPC G06Q 30/0621; G06F 40/20; G06Q 30/0203

(57) ABSTRACT

An online system performs item redesign and engagement prediction. The system obtains item data describing characteristics of a target item for redesign. The system generates a prompt including the characteristics and directions to redesign at least one of them. The system executes the prompt on a generative model to output redesigns. Each redesign includes a modification to at least one characteristic of the target item. The system inputs features of variants, each variant include one store location and one redesign, into an engagement prediction model to output an engagement score for the variant. The engagement prediction model is trained on historical data describing levels of user engagement with items in association with the many store locations. The system identifies candidate variants based on the user engagement scores for further testing. The system transmits the candidate variants to a testing system to assess viability of the redesign.

### BACKGROUND

In the sphere of item design, substantial resources are expended during the rollout of new items or variants of current items, owed largely to the challenges associated with ascertaining a tangible synchronization between an item's design and the ensuing user engagement. These new items or item redesigns ordinarily need to go through extensive user testing, which itself would require large resources to coordinate the widespread distribution and tracking of engagement. However, forgoing such user testing could likewise cause wasted resources through unknown reception of new items or item redesigns. This two-edged problem creates a technological challenge in launching new designs and/or redesigns. These challenges exacerbate the strain on resources and underpin the need for technological solutions to item design.

### SUMMARY

An online system performs item redesign and engagement prediction. The system obtains item data describing characteristics of a target item for redesign. The system generates a prompt including the characteristics and directions to redesign at least one of them. The system executes the prompt on a generative model to output redesigns. Each redesign includes a modification to at least one characteristic of the target item. The system inputs tuples of store location and redesign into an engagement prediction model to output an engagement score for each tuple. The engagement prediction model is trained on historical data describing levels of user engagement with items across the plurality of locations. The system selects a set of candidate variants for testing by a testing system. The testing system may perform user engagement tests for each of the candidate variants. Testing may entail online testing, i.e., graphically rendering one or more characteristics of the redesign when a user is viewing a catalog of available items at a particular location. Testing may also entail physical testing, i.e., manufacturing the redesign of the target item for placement at the in-store location.

Harnessing the power of a generative model provides for a technological improvement to item redesign. The generative model learns underlying patterns and standards from previously successful designs and applies them to redesign a target item. Meanwhile, by employing a predictive model, the online system can predict user engagement tied to these redesigns ahead of their actual deployment. The predictive model does so by analyzing historical user engagement data in relation to characteristics associated with the target item, hence forecasting user response to redesigns of that target item. In combination, these two models can effectively mitigate the technological challenges described earlier, providing a scalable rollout of new items or redesigns.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 is an illustrative flowchart describing item redesign and engagement prediction of the redesigns, in accordance with one or more embodiments.

FIG. 4 is a method flowchart describing the process of item redesign and engagement prediction of the redesigns, in accordance with one or more embodiments.

### DETAILED DESCRIPTION de

### online system environment

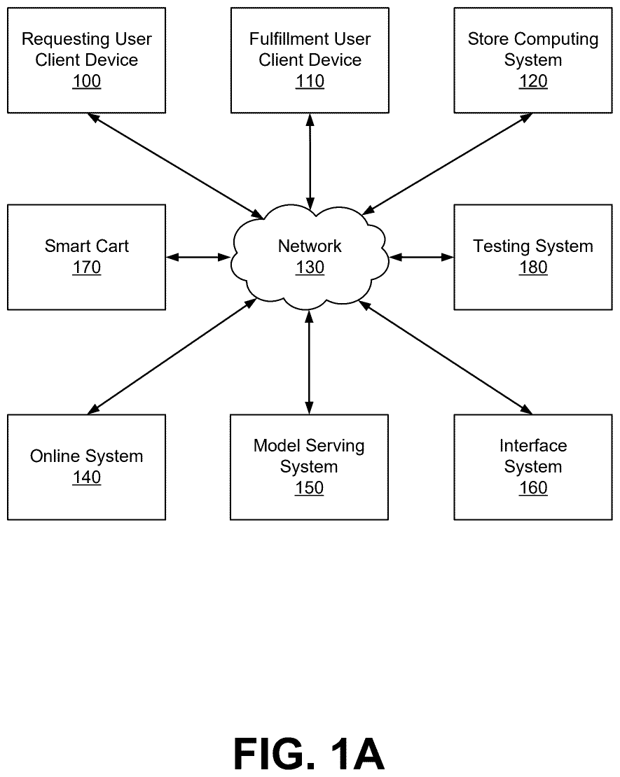

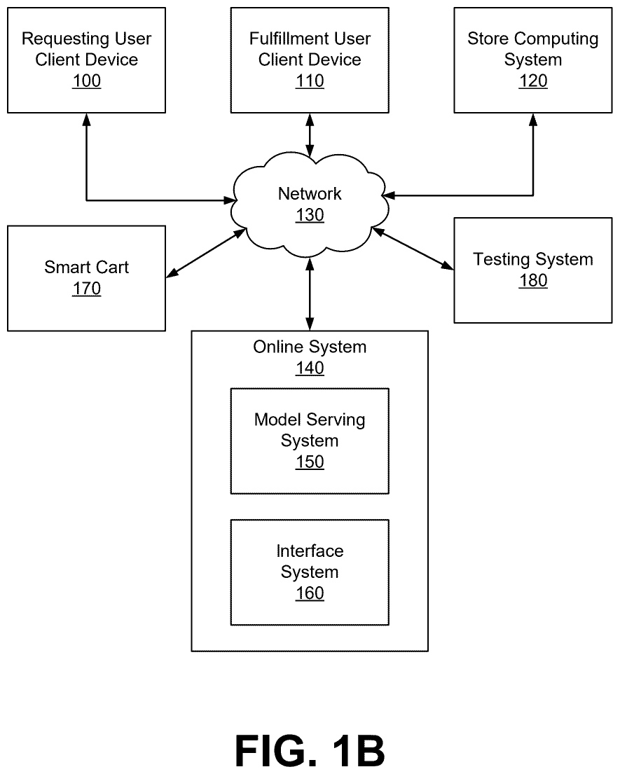

FIG. 1A illustrates an example system environment for an online system 140, in accordance with one or more embodiments. The system environment illustrated in FIG. 1A includes a requesting user client device 100, a picking user client device 110, a store computing system 120, a network 130, an online system 140, a model serving system 150, an interface system 160, and a smart cart 170. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, requesting users, picking users, and stores may be generically referred to as “users” of the online system 140. Additionally, while one requesting user client device 100, one picking user client device 110, one store computing system 120, one smart cart 170 are illustrated in FIG. 1, any number of client devices, stores, or smart carts may interact with the online system 140. As such, there may be more than one requesting user client device 100, more than one picking user client device 110, more than one store computing system 120, or more than one smart cart 170.

The requesting user client device 100 is a client device through which a requesting user may interact with the picking user client device 110, the store computing system 120, or the online system 140. The requesting user client device 100 can be a personal or mobile computing device, such as a smartphone, a tablet, a laptop computer, or desktop computer. In some embodiments, the requesting user client device 100 executes a client application that uses an application programming interface (API) to communicate with the online system 140.

A requesting user uses the requesting user client device 100 to place an order with the online system 140. A requesting user may also be referred to as a requesting user that provides orders to the online system 140 for completion. An order specifies a set of items to be delivered to the requesting user. An “item,” as used herein, means a good, a product, or a service that can be provided to the requesting user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more store locations from which the ordered items should be collected.

The requesting user client device 100 presents an ordering interface to the requesting user. The ordering interface is a user interface that the requesting user can use to place an order with the online system 140. The ordering interface may be a part of a client application operating on the requesting user client device 100. The ordering interface is a graphical user interface. The ordering interface allows the requesting user to search for items that are available through the online system 140. To perform a search, the requesting user provides a query (e.g., a text query, an audio query, or a visual query) to the online system 140. The online system 140 processes the query to return query results to the requesting user. The ordering interface graphically presents items corresponding to the query results, e.g., by obtaining characteristics of the items from a database and graphically rendering the characteristics in the interface. Based on the displayed results, the requesting user can select which items to add to an “item list. ” An “item list,” as used herein, is a tentative set of items that the user has selected for an order but that has not yet been finalized for an order. The ordering interface allows a requesting user to update the item list, e.g., by changing the quantity of items, adding or removing items, or adding instructions for items that specify how the item should be collected. The user interface may also include options to provide input for user preferences. For example, the requesting user may, via the user interface, provide input tagging one or more items as favorite items. In another example, the requesting user may, via the user interface, provide input (e.g., in the form of user feedback or user messages) to past orders. The ordering interface may track user engagement with items presented in the interface. In some embodiments, the ordering interface tracks impressions of an item in the ordering interface, clicking on the item to view further details, adding the item to an item list, submitting an order with item, favoriting the item, etc.

The requesting user client device 100 may receive additional content from the online system 140 to present to a requesting user. For example, the requesting user client device 100 may receive coupons, recipes, or item suggestions. The requesting user client device 100 may present the received additional content to the requesting user as the requesting user uses the requesting user client device 100 to place an order (e.g., as part of the ordering interface).

Additionally, the requesting user client device 100 includes a communication interface that allows the requesting user to communicate with a picking user that is servicing the requesting user's order. This communication interface allows the user to input a text-based message to transmit to the picking user client device 110 via the network 130. The picking user client device 110 receives the message from the requesting user client device 100 and presents the message to the picking user. The picking user client device 110 also includes a communication interface that allows the picking user to communicate with the requesting user. The picking user client device 110 transmits a message provided by the picking user to the requesting user client device 100 via the network 130. In some embodiments, messages sent between the requesting user client device 100 and the picking user client device 110 are transmitted through the online system 140. In addition to text messages, the communication interfaces of the requesting user client device 100 and the picking user client device 110 may allow the requesting user and the picking user to communicate through audio or video communications, such as a phone call, a voice-over-IP call, or a video call.

The picking user client device 110 is a client device through which a picking user may interact with the requesting user client device 100, the store computing system 120, or the online system 140. The picking user client device 110 can be a personal or mobile computing device, such as a smartphone, a tablet, a laptop computer, or desktop computer. In some embodiments, the picking user client device 110 executes a client application that uses an application programming interface (API) to communicate with the online system 140.

The picking user client device 110 selects orders for completion. The online system 140 may present active and unselected orders submitted by requesting users. The picking user, via the picking user client device 110, may select one or more of the orders for completion. Upon selection (and approval by the online system 140), the picking user client device 110 receives the orders from the online system 140 for the picking user to service. Items in the order may be presented in a particular sequence (i.e., display order) to optimize efficiency of the picking user. A picking user services an order by collecting the items listed in the order from a store. The picking user client device 110 presents the items that are included in the requesting user's order to the picking user in a collection interface. The collection interface is a user interface that provides information to the picking user on which items to collect for a requesting user's order and the quantities of the items. In some embodiments, the collection interface provides multiple orders from multiple requesting users for the picking user to service at the same time from the same store location. The collection interface further presents instructions that the requesting user may have included related to the collection of items in the order. Additionally, the collection interface may present a location of each item at the store, and may even specify a sequence in which the picking user should collect the items for improved efficiency in collecting items. In some embodiments, the picking user client device 110 transmits to the online system 140 or the requesting user client device 100 which items the picking user has collected in real time as the picking user collects the items.

The picking user can use the picking user client device 110 to keep track of the items that the picking user has collected to ensure that the picking user collects all of the items for an order. The picking user client device 110 may include a barcode scanner that can determine an item identifier encoded in a barcode coupled to an item. The picking user client device 110 compares this item identifier to items in the order that the picking user is servicing, and if the item identifier corresponds to an item in the order, the picking user client device 110 identifies the item as collected. In some embodiments, rather than or in addition to using a barcode scanner, the picking user client device 110 captures one or more images of the item and determines the item identifier for the item based on the images. The picking user client device 110 may determine the item identifier directly or by transmitting the images to the online system 140. Furthermore, the picking user client device 110 determines a weight for items that are priced by weight. The picking user client device 110 may prompt the picking user to manually input the weight of an item or may communicate with a weighing system in the store location to receive the weight of an item.

When the picking user has collected all of the items for an order, the picking user client device 110 instructs a picking user on where to deliver the items for a requesting user's order. For example, the picking user client device 110 displays a delivery location from the order to the picking user. The picking user client device 110 also provides navigation instructions for the picking user to travel from the store location to the delivery location. When a picking user is servicing more than one order, the picking user client device 110 identifies which items should be delivered to which delivery location. The picking user client device 110 may provide navigation instructions from the store location to each of the delivery locations. The picking user client device 110 may receive one or more delivery locations from the online system 140 and may provide the delivery locations to the picking user so that the picking user can deliver the corresponding one or more orders to those locations. The picking user client device 110 may also provide navigation instructions for the picking user from the store location from which the picking user collected the items to the one or more delivery locations.

In some embodiments, the picking user client device 110 tracks the location of the picking user as the picking user delivers orders to delivery locations. The picking user client device 110 collects location data and transmits the location data to the online system 140. The online system 140 may transmit the location data to the requesting user client device 100 for display to the requesting user, so that the requesting user can keep track of when their order will be delivered. Additionally, the online system 140 may generate updated navigation instructions for the picking user based on the picking user's location. For example, if the picking user takes a wrong turn while traveling to a delivery location, the online system 140 determines the picking user's updated location based on location data from the picking user client device 110 and generates updated navigation instructions for the picking user based on the updated location.

The picking user client device 110 may also provide a communication interface to the picking user, e.g., to communicate with another user of the online system 140. For example, the communication interface of the picking user client device 110 may present messages from a requesting user client device 100 to the picking user client device 110. Such communication may be utilized when items in an order are unavailable at the store location. In such scenarios, the picking user may query the requesting user for suitable substitution items to be obtained for the unavailable item. The messages may be in the form of text, audio, pictures, other digital manners of communicating information, etc.

In one or more embodiments, the picking user is a single person who collects items for an order from a store location and delivers the order to the delivery location for the order. Alternatively, more than one person may serve the role as a picking user for an order. For example, multiple people may collect the items at the store location for a single order. Similarly, the person who delivers an order to its delivery location may be different from the person or people who collected the items from the store location. In these embodiments, each person may have a picking user client device 110 that they can use to interact with the online system 140.

The store computing system 120 is a computing system operated by a store that interacts with the online system 140. As used herein, a “store” is an entity that operates a “store location,” which is a store, warehouse, or other building from which a picking user can collect items. The store computing system 120 stores and provides item data to the online system 140 and may regularly update the online system 140 with updated item data. For example, the store computing system 120 provides item data indicating which items are available at a particular store location and the quantities of those items. Additionally, the store computing system 120 may transmit updated item data to the online system 140 when an item is no longer available at the store location. Additionally, the store computing system 120 may provide the online system 140 with updated item prices, sales, or availabilities. Additionally, the store computing system 120 may receive payment information from the online system 140 for orders serviced by the online system 140. Alternatively, the store computing system 120 may provide payment to the online system 140 for some portion of the overall cost of a user's order (e.g., as a commission).

The store computing system 120 may provide the online system 140 with store data describing the store associated with the store computing system 120. The store data may include store name, store address, store website, store phone number, other identifying information, a type of store, an expense class of the store (e.g., $, $$, or $$$), opening hours, general dependability of items, diversity of items, types of items carried, or information describing the store, or some combination thereof. The online system 140 may further infer additional store data based on interactions between requesting users or picking users and the store. For example, such store data based on the interactions may include requesting user reviews, picking user reviews, popular items ordered, dependability of items, etc.

In one or more embodiments, the store computing system 120 may include a cart tracking system for tracking locations of smart carts throughout the in-store environment. In one or more embodiments, the cart tracking system may implement sensors positioned around the in-store environment and/or sensors coupled to the smart carts. In embodiments with sensors positioned around the in-store environment, the sensors may wirelessly communicate with counterpart devices on the smart carts to determine a location of each smart cart. In embodiments with sensors coupled to the smart carts, the sensors may wirelessly communicate with counterpart devices positioned around the in-store environment to determine a location of each smart cart. For example, the sensors may communicate with radiofrequency identifier (RFID) tags to triangulate a position of the sensors and/or the RFID tags. In one example, each smart cart includes a RFID reader as the sensor which receives signals from RFID tags positioned around the in-store environment. Based on the received signals, the tracking system can triangulate a position of the smart cart. In another example, each smart cart includes an RFID tag and RFID readers positioned around the in-store environment can read the signal from the cart's RFID tag to triangulate a position of the smart cart. In other embodiments, each smart cart may include additional components to aid in locating the smart cart in the in-store environment, including: wheel sensors, accelerometers, inertial measurement units, magnetometers, imaging devices, inclinometers, etc. Additional description relating to cart tracking is described in U.S. application Ser. No. 17/873,526 filed on Jul. 26, 2022, which is incorporated by reference in its entirety.

The requesting user client device 100, the picking user client device 110, the store computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, x4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which requesting users can order items to be provided to them by a picking user from a store. The online system 140 receives orders from a requesting user client device 100 through the network 130. The online system 140 selects a picking user to service the requesting user's order and transmits the order to a picking user client device 110 associated with the picking user. The picking user collects the ordered items from a store location and delivers the ordered items to the requesting user. The online system 140 may charge a requesting user for the order and provide portions of the payment from the requesting user to the picking user and the store.

As an example, the online system 140 may allow a requesting user to order groceries from a grocery store. The requesting user's order may specify which groceries they want delivered from the grocery store and the quantities of each of the groceries. The requesting user's client device 100 transmits the requesting user's order to the online system 140 and the online system 140 selects a picking user to travel to the grocery store location to collect the groceries ordered by the requesting user. Once the picking user has collected the groceries ordered by the requesting user, the picking user delivers the groceries to a location transmitted to the picking user client device 110 by the online system 140.

In one or more embodiments, the online system 140 performs redesign of items. The online system 140 may leverage a generative machine-learning model to generate redesigns of a target item. The redesigns may modify one or more characteristics of the target item (e.g., item packaging, text descriptions of the target item, a name of the target item, flavor profile of the target item, nutritional content). For example, the generative machine-learning model may output redesigns to the item packaging for an item. In another example, the generative machine-learning model may output redesigns to the item's textual description. In other examples, the generative machine-learning model may output redesigns to the item's flavor profile (e.g., from barbeque flavor to honey mesquite barbeque flavor). The online system 140 may iterate on the redesigns, e.g., performing multiple rounds of modifications in redesigning the item. The redesigns may reflect changes to the graphical representation of the item (e.g., modified item packaging, modified textual description, etc.).

In one or more embodiments, the online system 140 predicts user engagement with the redesigns of an item. The online system 140 may leverage an engagement prediction model trained to output an engagement score indicating a predicted level of user engagement with a redesign. The engagement prediction model may be trained on historical data by requesting users of the online system (e.g., order data, engagement data, etc.). In some embodiments, the engagement prediction model is configured to input a tuple of data comprising a store location and a redesign. In such embodiments, the online system 140 may parse the historical data into tuples for training the engagement prediction model. The engagement prediction model is trained, in such embodiments, to output the engagement score indicating the predicted level of user engagement with the redesign, specifically among users ordering at the store location. The online system 140 may use the engagement score to identify redesigns to pursue. In embodiments with redesigns, the online system 140 may update the item database to include the redesign for the target item. When generating an ordering interface for users ordering at the store location, the online system 140 may retrieve the redesign to graphically represent the target item. In embodiments with redesigns to the item's constitution (e.g., flavor profile, nutritional content), the online system 140 may provide the redesign to an item manufacturer for modifying a recipe for crafting the target item.

The online system 140 may track user engagement with the item redesigns to fine tune the generative machine-learning model, the engagement model, or some combination thereof. Successful redesigns can be used as positive training examples (i.e., mimic redesigning similar to these successful redesigns), whereas unsuccessful redesigns can be used as negative training examples (i.e., avoid redesigning similar to these unsuccessful redesigns). Successful redesigns can be rolled out to additional store locations.

Combination of the generative machine-learning model and the engagement prediction model provides the foundation for a scalable item redesign platform. The generative aspect is advantageous in identifying a large number of redesigns. The engagement prediction facilitates preemptive prediction of user engagement of the large number of redesigns. From the engagement prediction, the online system 140 may perform small scale trials of item redesigns predicted to have high user engagement (i.e., above a threshold engagement score, or selected from a ranking of redesigns based on the engagement scores). Item redesigns that perform well (i.e., resulting in user engagement around or above the predicted level of engagement) can be scaled up, e.g., distributed to a larger number of store locations. This mitigates waste of resources spent in trials of redesigns.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are language models configured to perform one or more NLP tasks. The NLP tasks include, but are not limited to, text generation, query processing, machine translation, chatbots, and the like. In one or more embodiments, a language model of the model serving system 150 is configured as a transformer neural network architecture (i.e., a transformer model). Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. The language model can be configured as any other appropriate architecture including, but not limited to, transformer-based networks, long short-term memory (LSTM) networks, Markov networks, BART, generative-adversarial networks (GAN), diffusion models (e.g., Diffusion-LM), and the like.

In one or more embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one order fulfillment instance, the context in the prompt includes portions of the structured indices as contextual information for the query. The interface system 160 obtains one or more responses from the model serving system 150 and synthesizes a response to the query on the external data. While the online system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

The smart cart 170 is a cart (e.g., a shopping cart) with one or more sensors and a computing device. The one or more sensors may detect various information relating to the smart cart 170. The sensors may include cameras and/or load sensors coupled to the baskets of the smart cart 170. The cameras can capture image data of items obtained. The load sensors can capture load data indicating a load on each basket. Further example sensors include a scanner for scanning items that are placed into the smart cart 170, a location sensor for tracking a position of the smart cart 170 in the in-store environment, etc. The computing device of the smart cart 170 processes the data captured by the sensors and, optionally, other data provided from other components of the system environment, e.g., the requesting user client device 100, the picking user client device 110, the store computing system 120, the online system 140, etc.

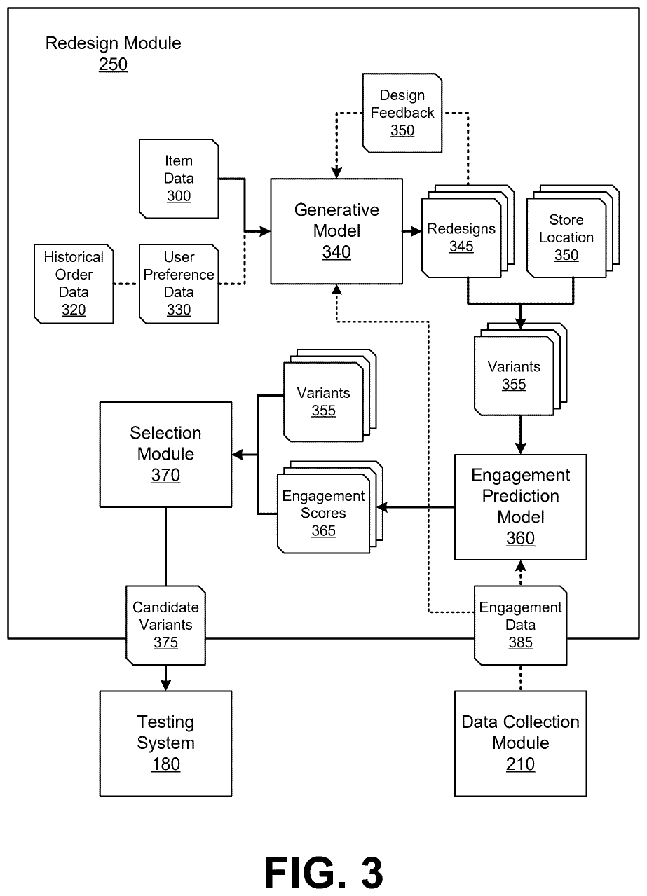

The computing device can provide content to the user of the smart cart 170 during their store visit. The content may be generated by the smart cart 170 and/or other components of the system environment. The functionality of the smart cart 170 is further described in FIGS. 3-7.

In some examples, a requesting user can use the smart cart 170. In such examples, the smart cart 170 may access a profile on the requesting user, e.g., to retrieve relevant user preference data. The requesting user could also provide a list, such that the smart cart 170 can assist the requesting user in filling the list, e.g., like an order. The smart cart 170 may also present a graphical user interface on an electronic display of the smart cart 170. The user may interact with the graphical user interface, e.g., to query to view items, to add items to an item list, etc.

In other examples, a picking user can user the smart cart 170 to fulfill orders by requesting users of the online system 140. In such examples, the smart cart 170 can perform functionality of the picking user client device 110. The smart cart 170 may also generate and provide fulfillment instructions to assist the picking user in fulfilling the batch of orders.

The testing system 180 performs one or more tests on redesigns of a target item to assess viability (e.g., user engagement) with the redesign. In one or more embodiments, the testing system 180 may perform online testing, i.e., the redesigned target item's characteristics are graphically rendered for deployment within an online catalog. As such, a requesting user interacting with the online catalog will perceive the redesigned product among the catalog selection. As the requesting user interacts with the redesigned item, the testing system 180 may track the user engagement with the redesign. In one or more embodiments, the testing system 180 may perform in-store testing as a tangible means of measuring user engagement with the redesigns. This in-store testing may entail manufacturing the redesigned target item and strategically placing it at the physical in-store location. In some embodiments, the testing system 180 may perform tiered testing, e.g., starting at a small scale, then expanding to larger scales. For example, the testing system 180 may initially test the redesign with online testing to assess initial viability. If there's sufficient traction, then the testing system 180 may progress to in-store testing, i.e., at particular in-store locations. Based on initial in-store testing, the testing system 180 may increase breadth of the in-store testing.

FIG. 1B illustrates an example system environment for an online system 140, in accordance with one or more embodiments. The system environment illustrated in FIG. 1B includes a requesting user client device 100, a picking user client device 110, a store computing system 120, a network 130, an online system 140, and a smart cart 170. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

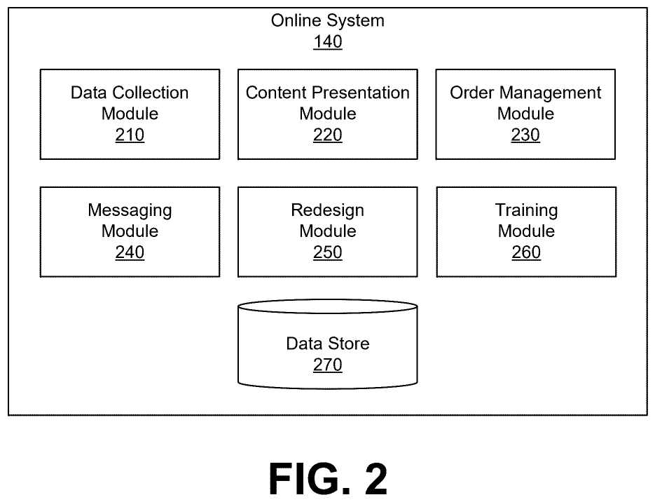

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140. The online system 140 is described in further detail below with regards to FIG. 2.

### Online System Architecture

FIG. 2 illustrates an example system architecture for an online system 140, in accordance with some embodiments. The system architecture illustrated in FIG. 2 includes a data collection module 210, a content presentation module 220, an order management module 230, a messaging module 240, a redesign module 250, a training module 260, and a data store 270. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 210 collects data used by the online system 140 and stores the data in the data store 270. The data collection module 210 may only collect data describing a user if the user has previously explicitly consented to the online system 140 collecting data describing the user. Additionally, the data collection module 210 may encrypt all data, including sensitive or personal data, describing users.

For example, the data collection module 210 collects requesting user data, which is information or data that describe characteristics of a requesting user. For example, the data collection module 210 may collect a requesting user's name, address, other demographic information (e.g., age range, family size, dietary restrictions or preferences, etc.), preferences (e.g., store visit frequency, order magnitude, etc.), previous orders, favorite items, favorite types of items, favorite stores, favorite picking users, repeat picking users, stored payment instruments, health sensor data, fitness objectives, or some combination thereof. The requesting user data also may include default settings established by the requesting user, such as a default store/store location, payment instrument, delivery location, or delivery timeframe. The requesting user data may also include user preference data indicating one or more preferences, e.g., provided by the user and/or inferred by the online system 140. The data collection module 210 may collect the requesting user data from sensors on the requesting user client device 100 or based on the requesting user's interactions with the online system 140.

The data collection module 210 also collects item data, which is information or data that identifies and describes items that are available at a store location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the dependability of items in store locations, also referred to as “dependability.” For example, for each item-store combination (a particular item at a particular warehouse), the item data may include a time that the item was last found, a time that the item was last not found (a picking user looked for the item but could not find it), the rate at which the item is found, or the popularity of the item. The data collection module 210 may collect item data from a store computing system 120, a picking user client device 110, or the requesting user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 210 also collects picking user data, which is information or data that describes characteristics of picking users. For example, the data collection module 210 may collect the picking user's name, the picking user's location, how often the picking user has serviced orders for the online system 140, a requesting user rating for the picking user, a number of requesting users that have favorited the picking user, which stores the picking user has collected items at, or the picking user's previous shopping history. The data collection module 210 may also collect information describing the manner in which the picking user completes orders. For example, the information may describe one or more route(s) taken to and/or from the store location(s), one or more route(s) taken within the in-store environment, a conversation between the supposed picking user and a requesting user corresponding to the order(s), other metrics relating to completion of the order, etc. Additionally, the picking user data may include preferences expressed by the picking user, such as their preferred stores to collect items at, how far they are willing to travel to deliver items to a requesting user, how many items they are willing to collect at a time, timeframes within which the picking user is willing to service orders, payment information by which the picking user is to be paid for servicing orders (e.g., a bank account), feedback from the picking user in fulfilling requesting user orders, etc. The data collection module 210 collects picking user data from sensors of the picking user client device 110 or from the picking user's interactions with the online system 140.

Additionally, the data collection module 210 collects order data, which is information or data that describes characteristics of an order. For example, order data may include item data for items that are included in the order, a delivery location for the order, a requesting user associated with the order, a store location from which the requesting user wants the ordered items collected, or a timeframe within which the requesting user wants the order delivered. Order data may further include information describing how the order was serviced, such as which picking user serviced the order, when the order was delivered, or a rating that the requesting user gave the delivery of the order. In some embodiments, the order data includes user data for users associated with the order, such as requesting user data for a requesting user who placed the order or picking user data for a picking user who serviced the order.

The content presentation module 220 selects content for presentation to a user. For example, the content presentation module 220 selects which items to present to a requesting user while the requesting user is placing an order and/or using a smart cart during an in-store visit. In embodiments with the requesting user placing an order, the content presentation module 220 generates and transmits an ordering interface for the requesting user to order items. The content presentation module 220 populates the ordering interface with items that the requesting user may select for adding to their order. In some embodiments, the content presentation module 220 presents a catalog of all items that are available to the requesting user, which the requesting user can browse to select items to order. The content presentation module 220 also may identify items that the requesting user is most likely to order and present those items to the requesting user. For example, the content presentation module 220 may score items and rank the items based on their scores. The content presentation module 220 displays the items with scores that exceed some threshold (e.g., the top n items or the p percentile of items). The ordering interface may be configured to present redesigns of items, e.g., as generated and identified by the redesign module 250.

In embodiments with the requesting user using a smart cart during an in-store visit, the content presentation module 220 may generate and transmit a cart interface for presentation on the smart cart 170. In other embodiments, the smart cart 170 may generate the cart interface. The cart interface may provide details about the user and/or the in-store visit, a list of one or more items in the smart cart, one or more item recommendations, or some combination thereof. The content presentation module 220 may implement a recommendation model for determining one or more item recommendations for presentation in the cart interface. The content presentation module 220 may train the recommendation model as a machine-learning model, and, optionally, as a multimodal model. In one or more embodiments, the recommendation model may input a list of items in a smart cart 170, a location of the smart cart 170 in the in-store environment, items in the item database, other contextual data, or some combination thereof.

The content presentation module 220 may use a scoring function to score items for presentation to a requesting user. The scoring function may score items for a requesting user based on item data for the items and requesting user data for the requesting user. The scoring function may determine a ranking score based on ranking parameter values for each item and a weight vector. In some embodiments, an item selection model trained as a machine-learning model may determine a likelihood that the requesting user will order the item. In some embodiments, the item selection model uses item embeddings describing items and requesting user embeddings describing requesting users to score items. These item embeddings and requesting user embeddings may be generated by separate machine-learning models and may be stored in the data store 270.

The order management module 230 manages orders by requesting users. The order management module 230 receives orders from a requesting user client device 100. Picking users may select orders provided to and received by the to order management module 230. For example, the order management module 230 may provide optionality to a picking user to select a particular order based on the picking user's location and the location of the store from which the ordered items are to be collected. The order management module 230 may also provide optionality to a picking user to select a particular order based on how many items are in the order, a vehicle operated by the picking user, the delivery location, the picking user's preferences on how far to travel to deliver an order, the picking user's ratings by requesting users, or how often a picking user agrees to service an order.

In some embodiments, the order management module 230 determines when to transmit an order to a picking user based on a delivery timeframe requested by the requesting user with the order. The order management module 230 computes an estimated amount of time that it would take for a picking user to collect the items for an order and deliver the ordered items to the delivery location for the order. The order management module 230 transmits the order to a picking user at a time such that, if the picking user immediately fulfills the order, the picking user is likely to deliver the order at a time within the requested timeframe. Thus, when the order management module 230 receives an order, the order management module 230 may delay in transmitting the order to a picking user if the requested timeframe is far enough in the future (i.e., the order management module 230 provides, at a later time, the optionality to the picking user to select an order, such that there is sufficient predicted time to meet the requested timeframe).

The order management module 230 transmits the order to an account associated with the picking user (or a client device accessing the account), e.g., with the content presentation module 220. The order management module 230 may also transmit navigation instructions from the picking user's current location to the store location associated with the order. If the order includes items to collect from multiple store locations, the order management module 230 identifies the store locations to the picking user and may also specify a sequence in which the picking user should visit the store locations.

The order management module 230 may track the location of the picking user through the picking user client device 110 to determine when the picking user arrives at the store location. When the picking user arrives at the store location, the order management module 230 transmits the order to the picking user client device 110 for display to the picking user. As the picking user uses the picking user client device 110 to collect items at the store location, the order management module 230 receives item identifiers for items that the picking user has collected for the order. In some embodiments, the order management module 230 receives images of items from the picking user client device 110 and applies computer-vision techniques to the images to identify the items depicted by the images. The order management module 230 may track the progress of the picking user as the picking user collects items for an order and may transmit progress updates to the requesting user client device 100 that describe which items have been collected for the requesting user's order.

The order management module 230 determines when the picking user has collected all of the items for an order. For example, the order management module 230 may receive a message from the picking user client device 110 indicating that all of the items for an order have been collected. Alternatively, the order management module 230 may receive item identifiers for items collected by the picking user and determine when all of the items in an order have been collected. When the order management module 230 determines that the picking user has completed an order, the order management module 230 transmits the delivery location for the order to the picking user client device 110. The order management module 230 may also transmit navigation instructions to the picking user client device 110 that specify how to travel from the store location to the delivery location, or to a subsequent store location for further item collection. The order management module 230 tracks the location of the picking user as the picking user travels to the delivery location for an order, and updates the requesting user with the location of the picking user so that the requesting user can track the progress of the order. In some embodiments, the order management module 230 computes an estimated time of arrival of the picking user at the delivery location and provides the estimated time of arrival to the requesting user.

The order management module 230 coordinates payment by the requesting user for the order. The order management module 230 uses payment information provided by the requesting user (e.g., a credit card number or a bank account) to receive payment for the order. In some embodiments, the order management module 230 stores the payment information for use in subsequent orders by the requesting user. The order management module 230 computes a total cost for the order and charges the requesting user that cost. The order management module 230 may provide a portion of the total cost to the picking user for servicing the order, and another portion of the total cost to the store. The order management module 230 may further provide an option to the requesting user to provide a tip to the picking user, e.g., for outstanding service.

The messaging module 240 facilitates communication between the requesting user client device 100 and the picking user client device 110. As noted above, a requesting user may use a requesting user client device 100 to send a message to the picking user client device 110. The messaging module 240 receives the message from the requesting user client device 100 and transmits the message to the picking user client device 110 for presentation to the picking user. The picking user may use the picking user client device 110 to send a message to the requesting user client device 100 in a similar manner. Communications between the requesting user and the picking user may be provided to the content presentation module 220.

The redesign module 250 performs redesign of items, e.g., to evaluate market reception of variations of items. The redesign module 250 obtains item data for a target item subject to redesign. The item data describes at least characteristics of the target item, including, e.g., a name of the item, a textual description of the item, the item's packaging, a flavor profile of the item, nutritional content of the item, historical user engagement with the item, etc. The redesign module 250 may further receive design input from the item manufacturer, specifying one or more target characteristics to guide redesign of the item. For example, the item manufacturer may indicate in the design input a target characteristic of a savory profile. The redesign module 250 generates an executable prompt for a generative machine-learning model (e.g., a LLM, a multimodal generative model, or some combination thereof), the prompt including characteristics of the target item and directions to redesign one or more of the characteristics of the target item. In some embodiments, the redesign module 250 transmits the prompt to the model serving system 150 to execute by the generative machine-learning model. Upon execution, the generative machine-learning model may output redesigns of the target item. Each redesign includes a modification to at least one characteristic of the target item (e.g., item packaging, text descriptions of the target item, a name of the target item, flavor profile of the target item, nutritional content). For example, the generative machine-learning model may output redesigns to the item packaging for an item. In another example, the generative machine-learning model may output redesigns to the item's textual description. In other examples, the generative machine-learning model may output redesigns to the item's flavor profile (e.g., from barbeque flavor to honey mesquite barbeque flavor).

In one or more embodiments, the redesign module 250 may iterate on the redesigns, e.g., performing multiple rounds of modifications in redesigning the item. In such embodiments, the online system 140 may provide the output redesigns to a human operator, e.g., of the item manufacturer. In such embodiments, the redesign module 250 may generate a design interface. The design interface may graphically illustrate the various characteristics of the target item. In presenting the redesign, the design interface may show the changed characteristics between the current design of the target item and the redesign. The human operator may provide additional design input, e.g., to further tailor the redesign. The redesign module 250 may generate subsequent prompt(s) with the redesign and the additional design input for iterative execution by the generative machine-learning model.

The redesign module 250 predicts user engagement with the redesigns of an item. The redesign module 250 may leverage an engagement prediction model trained to output an engagement score indicating a predicted level of user engagement with a redesign. The engagement prediction model may be trained on historical data by requesting users of the online system (e.g., order data, engagement data, etc.). In some embodiments, the engagement prediction model is configured to input a tuple of data comprising a store location and a redesign. The engagement prediction model is trained, in such embodiments, to output the engagement score indicating the predicted level of user engagement with the redesign, specifically among users ordering at the store location. The redesign module 250 may use the engagement score to identify redesigns to launch. In one or more embodiments, the redesign module 250 may rank the redesigns based on the output engagement scores. The redesign module 250 may select from the ranking, e.g., redesigns with an engagement score above a threshold score, or some top number of redesigns. In some embodiments, the redesign module 250 may select based on additional selection criteria, e.g., selecting a diverse set of redesigns (measured by how divergent changed characteristics are between redesigns).

In embodiments with redesigns, the redesign module 250 may update the item database to include the redesign for the target item. When generating an ordering interface for users ordering at the store location, the content presentation module 210 may retrieve the redesign to graphically represent the target item.

In embodiments with redesigns to the item's constitution (e.g., flavor profile, nutritional content), the redesign module 250 may provide the redesign to an item manufacturer for modifying a recipe for crafting the target item. In some embodiments, the generative machine-learning model may be leveraged to generate the modified recipe. For example, the redesign module 250 may generate a subsequent prompt including the recipe with directions to modify the recipe to achieve the target nutritional content and/or flavor profile. The generative machine-learning model may output the modified recipe. The redesign module 250 may provide the modified recipe to the item manufacturer in conjunction with the redesign.

The data collection module 210 may track user engagement with the item redesigns. Once the redesigns are launched (e.g., presented in the ordering interface and ordered by requesting users), the data collection module 210 may track impressions of the redesigns, favoriting redesigns, adding redesigns to orders, other user engagement actions in connection with the redesigns. The training module 260 may leverage the user engagement to fine tune the generative machine-learning model, the engagement model, or some combination thereof. Successful redesigns can be used as positive training examples (i.e., mimic redesigning similar to these successful redesigns), whereas unsuccessful redesigns can be used as negative training examples (i.e., avoid redesigning similar to these unsuccessful redesigns). Successful redesigns can be rolled out to additional store locations.

The training module 260 trains machine-learning models used by the online system 140. For example, the training module 260 may train the item selection model, the the query processing models, the featurization model, the spoofing prediction model, the language model, or any of the machine-learned models deployed by the model serving system 150. The online system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The training module 260 generates the set of parameters (e.g., the particular values of the parameters) for a machine-learning model by “training” the machine-learning model. Once trained, the machine-learning model uses the set of parameters to transform inputs into outputs.

The training module 260 trains a machine-learning model based on a set of training examples. Each training example includes input data to which the machine-learning model is applied to generate an output. For example, each training example may include requesting user data, picking user data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The training module 260 may apply an iterative process to train a machine-learning model whereby the training module 260 updates parameter values of the machine-learning model based on each of the set of training examples. The training examples may be processed together, individually, or in batches. To train a machine-learning model based on a training example, the training module 260 applies the machine-learning model to the input data in the training example to generate an output based on a current set of parameter values. The training module 260 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross-entropy loss function. The training module 260 updates the set of parameters for the machine-learning model based on the score generated by the loss function. For example, the training module 260 may apply gradient descent to update the set of parameters.

In one or more embodiments, the training module 260 may train the generative machine-learning model configured to perform the item redesign. To train the generative machine-learning model, the training module 260 may obtain user preference data including at least item trends (e.g., trends in items engaged with, or trends in items ordered), historical order data for historical orders placed by requesting users, item data associated with the items in the historical orders, other contextual information relevant to informing user engagement with item designs, or some combination thereof. The training module 260 may feed the obtained data to the generative machine-learning model to tune the generative model's output. For example, the generative model may be trained to bias towards frequently ordered items and/or user preference trends. As another example, the generative model may be trained to bias away from items with low engagement.

In one or more embodiments, the training module 260 may train the engagement prediction model configured to output an engagement score indicating a predicted level of engagement for an item's design (or, more specifically, an item's redesign). The training module 260 may obtain engagement data describing engagement by requesting users with items in the item catalog and item data describing the items interacted with. The engagement data may be derived from, e.g., historical order data. The training module 260 trains the engagement prediction model with the engagement data and the item data, e.g., in a supervised learning manner. The trained engagement prediction model is trained to input an item's design and to output an engagement score. In some embodiments, the training module 260 configures the engagement prediction model to input a tuple of data including a particular store location and an item's design to output the user engagement score indicating a predicted level of engagement with the item's design by users ordering from the particular store location. The training module 260 may, alternatively, configure the engagement prediction model to input another tuple of data limiting a scope of the engagement data (e.g., a season of the year, a geographical region of a country, a demographic of users, etc.). To train such engagement prediction model, the training module 260 may parse the training data into the appropriate tuple format.

In one or more embodiments, the training module 260 may fine tune the various models of the online system 140. In one or more embodiments, the training module 260 may receive user engagement data with one or more item redesigns. The training module 260 may leverage the user engagement data to fine tune (i.e., retrain) the generative machine-learning model, the engagement prediction model, or some combination thereof.

The data store 270 stores data used by the online system 140. For example, the data store 270 stores requesting user data, store data, item data, order data, and picking user data for use by the online system 140. The data store 270 also stores trained machine-learning models trained by the training module 260. For example, the data store 270 may store the set of parameters for a trained machine-learning model on one or more non-transitory, computer-readable media. The data store 270 uses computer-readable media to store data, and may use databases to organize the stored data.

With respect to the machine-learned models hosted by the model serving system 150, the machine-learned models may already be trained by a separate entity from the entity responsible for the online system 140. In one or more other embodiments, when the model serving system 150 is included in the online system 140, the training module 260 may further train parameters of the machine-learned model based on data specific to the online system 140 stored in the data store 270. As an example, the training module 260 may obtain a pre-trained transformer language model and further fine-tune the parameters of the transformer model using training data stored in the data store 270. The training module 260 may provide the model to the model serving system 150 for deployment.

### Item Redesign and Engagement Prediction

FIG. 3 is an illustrative flowchart describing item redesign and engagement prediction of the redesigns, in accordance with one or more embodiments. The description of FIG. 3 is focused from the perspective of the redesign module 250 of the online system 140. In other embodiments, some or all of the functionality described in FIG. 3 can be performed by another system. Moreover, the principles described in FIG. 3 are applicable to any user (in addition to picking users described in FIG. 3).

The redesign module 250 obtains item data 300 describing a target item to be redesigned. The item data 300 of the target item describe characteristics of the target item, i.e., a current design. The redesign module 250 generates a prompt for execution by a generative model 340. The prompt may include the item data 300 of the target item and instructions to redesign the target item. In some embodiments, the redesign module 250 may further include historical order data 320, user preference data 330, or some combination thereof in the executable prompt, e.g., to further inform the redesign process by the generative model 340. The generative model 340 outputs redesigns 345 for the target item, wherein each redesign may include a modification or change to at least one characteristic of the target item. In some embodiments, the redesign module 250 may present the redesigns to a human operator for design feedback. With the design feedback, the redesign module 250 may iterate on the redesigns. In some embodiments, the iterative redesign may be further informed by engagement prediction.

The redesign module 250 predicts user engagement with variants 355, each inclusive of a redesign and a store location, with an engagement prediction model 360. In some embodiments, the redesign module 250 may input features of the variant 355 (e.g., features relating to a redesign 345 and/or features relating to a store location 350) into the engagement prediction model 360 to output an engagement score 365 for the variant 355. In such embodiments, the engagement score 365 indicates a predicted level of user engagement by users limited according to the limiting factor, e.g., users ordering at the store location 350. In some embodiments, the redesign module 250 may cross all store locations in a geographical region (e.g., a country) with all redesigns 345. This could inform the best store location and redesign to perform a trial of the redesign.

The redesign module 250, via a selection module 370, selects a candidate variants 375 to launch with the testing system 180. The selection module 370 may select the candidate redesign as the redesign based on the user engagement scores 365, i.e., by ranking the variants 355 based on the engagement scores 365 and selecting the top engagement scores from the ranking. The selection module 370 may, alternatively, select the candidate variants 375 above a threshold score. In other embodiments, the selection module 370 may select according to other selection criteria, which may be evaluated in conjunction with the engagement scores. In some embodiments, the redesign module 250 may provide the variants 355 and the engagement scores 365 to a human operator for selecting the candidate variant 375.

The testing system 180 may conduct one or more tests for each of the candidate variants 375. Testing may entail online testing, i.e., the testing system 180 may present the redesign of a candidate variant in an ordering interface 380, e.g., on a requesting user client device 100. Testing may also entail in-store testing, i.e., the testing system 180 may provide the redesign of a candidate variant 375 to an item manufacturer for physically manufacturing the redesign of the target item. The manufactured redesigned target item can be placed in in-store locations (e.g., according to the candidate variants 375). The data collection module 210 may collect user engagement data 385 related to user engagement with the candidate variants 375, e.g., via online testing and/or in-store testing. The training module (not shown) may apply the engagement data to fine tune (i.e., retrain) the engagement prediction model 360 and/or the generative model 340.

### Example Methods

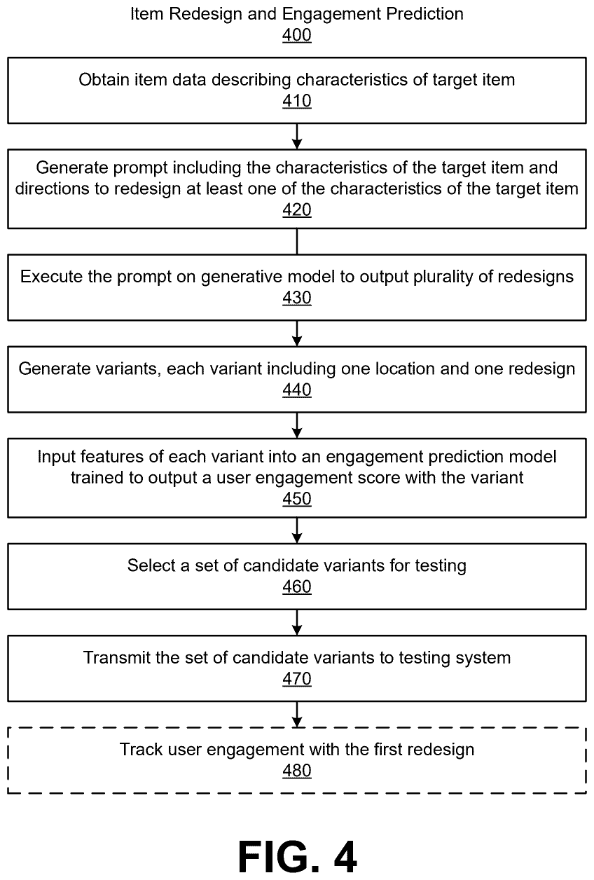

FIG. 4 is a method flowchart describing the process 400 of user spoofing detection and remediation, in accordance with one or more embodiments. The description of FIG. 4 is in the perspective of the online system (e.g., the online system 140), but in other embodiments, any computing system or device may perform any, some, or all of the steps.

The online system obtains 410 item data describing characteristics of a target item. The online system may maintain an item database storing item data describing various items offered by store locations hosted by the online system.

The online system generates 420 a prompt including the characteristics of the target item and directions to redesign at least one of the characteristics of the target item. Characteristics may include a packaging of the target item, characteristics comprising a textual description of the target item, characteristics describing a flavor profile of the target item, characteristics describing nutritional content of the target item, historical user engagement with the target item, or some combination thereof. In some embodiments, the online system gathers historical data describing user engagement trends with items in the item database. The online system may include the historical data in the prompt. In some embodiments, the online system may obtain design input from a human operator, e.g., of the item manufacturer, the design input indicating target characteristics for the redesign process.

The online system executes 430 the prompt on a generative model to output a plurality of redesigns. The generative model may be trained as a machine-learning model. In some embodiments, the generative model is a generative adversarial network (GAN), a variational autoencoder (VAE), an autoregressive model, a recurrent neural network (RNN), a transformer-based model, a language model, another type of machine-learning model configured to generate novel output, etc. Each redesign includes a modification to at least one characteristic of the target item. The redesigns may entail changes to graphical elements (e.g., name of the target item, textual description of the target item, packaging of the target item) and/or changes to a constitution of the target item (e.g., flavor profile of the target item, nutritional content of the target item). In some embodiments, executing the prompt entails providing the prompt to a model serving system to execute on the generative model.

In some embodiments, the online system may iterate through the redesign process. In such embodiments, the online system may transmit the generated redesigns (e.g., output by the generative model) to a device of the human operator. The human operator may provide, via their device, design feedback indicating changes to one or more of the redesigns. The online system may generate a subsequent prompt including the one or more redesigns associated with the design feedback and directions to iterate on the redesigns according to the design feedback. The online system may execute the subsequent prompt on the generative machine-learning model to iterate on the redesigns.

The online system generates 440 variants, each variant including one store location and one redesign. For example, with a plurality of store locations in a geographical region (e.g., a country) and a plurality of redesigns, the online system can enumerate through all possible combinations of one store location with one redesign. In some embodiments, the online system may utilize other limiting factors, i.e., to perform a small-scale trial of the redesign. For example, the online system may generate the variant to further enumerate by other criteria, e.g., user demographics, geographical region, season in the year, etc.

The online system inputs 450 features of each variant into an engagement prediction model trained to output a user engagement score. The user engagement score is a predicted level of user engagement with the redesign of the target item when made available at a store location. The engagement prediction model is trained on historical data describing levels of user engagement with items across the plurality of locations.

The online system selects 460 a set of candidate variants based on the user engagement scores to perform testing of a redesign of the target item. The online system may rank the variants based on the user engagement scores, and select the candidate variant from a top of the ranking. In some embodiments, the online system may perform multiple tests, e.g., selecting multiple candidate variants to launch in parallel. The different candidate variants can vary based on which store location to present the redesign, which redesign to launch, or some combination thereof.

The online system transmits 470 the set of candidate variants to a testing system to perform the testing. The testing system may perform online testing, in-store testing, or some combination thereof.

The online system may track 480 user engagement with the candidate variants tested. The online system may leverage the tracked user engagement to assess viability of the redesign at grander scales. For example, if the tracked user engagement does not surpass a threshold (or arise to the predicted level of engagement), the online system may deem the redesign to be unviable. Contrarily, if the tracked user engagement surpasses the threshold (or the predicted level of engagement), then the online system may deem the redesign to be viable at scale. The online system may expand the scale, i.e., launching the redesign to additional store locations. In embodiments with multiple candidate combinations launched, the online system may assess, based on the tracked user engagement, which combination performed better than counterparts. The online system may further leverage the tracked user engagement in fine tuning (i.e., re-training) the generative model, the engagement prediction model, or both.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor may comprise one or more sub-processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed by a computer system comprising a processor and a non-transitory computer-readable medium, comprising:
obtaining, from a database, item data describing characteristics of a target item, the characteristics comprising an image of the target item;
generating an executable prompt including the characteristics of the target item and directions to suggest a redesign of at least one of the characteristics of the target item;
executing the prompt on a generative artificial intelligence model to output a plurality of redesigns, wherein each redesign includes a modification to at least one characteristic of the target item;
generating a plurality of variants, each variant including one of a plurality of locations and one of the plurality of redesigns;
inputting features representing each variant into an engagement prediction model to output a user engagement score indicating a predicted level of user engagement with the redesign of the target item at the location associated with the variant, wherein the engagement prediction model is a machine-learning model trained on historical data describing levels of user engagement with items across the plurality of locations;
selecting a set of candidate variants based on the user engagement scores; and
transmitting the selected set of candidate variants to a testing system, causing the testing system to conduct, for each candidate variant in the set, a test of the redesign corresponding to the candidate variant at the location corresponding to the candidate variant against a control group comprising the target item.

2. The method of claim 1, wherein obtaining the item data describing the characteristics of the target item comprises one or more of:
obtaining characteristics describing a packaging of the target item;
obtaining a textual description of the target item;
obtaining a flavor profile of the target item;
obtaining nutritional content of the target item; or
obtaining historical information about user engagement with the target item.

3. The method of claim 1, further comprising:
obtaining trend data describing trends in user engagement with items in the database;
wherein generating the executable prompt comprises generating the executable prompt including the trend data.

4. The method of claim 1, further comprising:
obtaining design input describing one or more target characteristics to guide redesign of the target item;
wherein generating the executable prompt comprises generating the executable prompt including the design input.

5. The method of claim 1, further comprising:
transmitting, to another device, the redesigns of the target item;
receiving, from the device of the human operator, design feedback on one or more of the redesigns;
generating a subsequent prompt including the one or more redesigns associated with the design feedback and directions to iterate on the redesigns according to the design feedback; and
executing the subsequent prompt on the generative model.

6. The method of claim 1, wherein the generative model is trained as a large language model with the historical data describing levels of user engagement with items across the plurality of locations.

7. The method of claim 1, wherein enumerating the plurality of variants comprises enumerating each variant to further include one of a plurality of user demographic factors, wherein inputting features representing each variant into the engagement prediction model includes inputting features describing the user demographic factor into the engagement prediction model to output the user engagement score indicating the predicted level of user engagement of users classified under the user demographic factor with the redesign of the target item.

8. The method of claim 1, wherein selecting the set of candidate variants based on the user engagement scores comprises:
ranking the variants based on the user engagement scores; and
selecting the set of candidate variants from a top of the ranking.

9. The method of claim 1, further comprising:
receiving, from the testing system, tracked user engagement with a first redesign of the plurality of redesigns of the target item;
generating a positive training example based on the user engagement being above a threshold; and
re-training the generative model with the positive training example to bias the generative model towards the positive training example.

10. The method of claim 1, further comprising:
receiving, from the testing system, tracked user engagement with a first redesign of the plurality of redesigns of the target item;
generating a training example with the first redesign with an error between the user engagement and the user engagement score; and
re-training the user engagement model with the training example and the error.

11. The method of claim 1, further comprising:
receiving, from the testing system, tracked user engagement with each candidate variant;
identifying a first redesign from the candidate variants with tracked user engagement that is greater than the user engagement score predicted by the engagement prediction model; and
transmitting the first redesign to the testing system, causing the testing system to conduct a subsequent test of the first redesign at a plurality of additional locations.

12. A non-transitory computer-readable storage medium storing instructions that, when executed by a processor, cause the processor to perform operations comprising:
obtaining, from a database, item data describing characteristics of a target item, the characteristics comprising an image of the target item;
generating an executable prompt including the characteristics of the target item and directions to suggest a redesign of at least one of the characteristics of the target item;
executing the prompt on a generative artificial intelligence model to output a plurality of redesigns, wherein each redesign includes a modification to at least one characteristic of the target item;
generating a plurality of variants, each variant including one of a plurality of locations and one of the plurality of redesigns;
inputting features representing each variant into an engagement prediction model to output a user engagement score indicating a predicted level of user engagement with the redesign of the target item at the location associated with the variant, wherein the engagement prediction model is a machine-learning model trained on historical data describing levels of user engagement with items across the plurality of locations;
selecting a set of candidate variants based on the user engagement scores; and
transmitting the selected set of candidate variants to a testing system, causing the testing system to conduct, for each candidate variant in the set, a test of the redesign corresponding to the candidate variant at the location corresponding to the candidate variant against a control group comprising the target item.

13. The non-transitory computer-readable storage medium of claim 12, the operations further comprising:
obtaining trend data describing trends in user engagement with items in the database;
wherein generating the executable prompt comprises generating the executable prompt including the trend data.

14. The non-transitory computer-readable storage medium of claim 12, the operations further comprising:
obtaining design input describing one or more target characteristics to guide redesign of the target item;
wherein generating the executable prompt comprises generating the executable prompt including the design input.

15. The non-transitory computer-readable storage medium of claim 1, the operations further comprising:
transmitting, to another device, the redesigns of the target item;
receiving, from the device of the human operator, design feedback on one or more of the redesigns;
generating a subsequent prompt including the one or more redesigns associated with the design feedback and directions to iterate on the redesigns according to the design feedback; and
executing the subsequent prompt on the generative model.

16. The non-transitory computer-readable storage medium of claim 1, wherein enumerating the plurality of variants comprises enumerating each variant to further include one of a plurality of user demographic factors, wherein inputting features representing each variant into the engagement prediction model includes inputting features describing the user demographic factor into the engagement prediction model to output the user engagement score indicating the predicted level of user engagement of users classified under the user demographic factor with the redesign of the target item.

17. The non-transitory computer-readable storage medium of claim 1, the operations further comprising:
receiving, from the testing system, tracked user engagement with a first redesign of the plurality of redesigns of the target item;
generating a positive training example based on the user engagement being above a threshold; and
re-training the generative model with the positive training example to bias the generative model towards the positive training example.

18. The non-transitory computer-readable storage medium of claim 12, the operations further comprising:
receiving, from the testing system, tracked user engagement with a first redesign of the plurality of redesigns of the target item;
generating a training example with the first redesign with an error between the user engagement and the user engagement score; and
re-training the user engagement model with the training example and the error.

19. The non-transitory computer-readable storage medium of claim 1, the operations further comprising:
receiving, from the testing system, tracked user engagement with each candidate variant;
identifying a first redesign from the candidate variants with tracked user engagement that is greater than the user engagement score predicted by the engagement prediction model; and
transmitting the first redesign to the testing system, causing the testing system to conduct a subsequent test of the first redesign at a plurality of additional locations.

20. A system comprising:
a processor; and
a non-transitory computer-readable storage medium storing instructions that, when executed by the processor, cause the processor to perform operations comprising:
obtaining, from a database, item data describing characteristics of a target item, the characteristics comprising an image of the target item;
generating an executable prompt including the characteristics of the target item and directions to suggest a redesign of at least one of the characteristics of the target item;
executing the prompt on a generative artificial intelligence model to output a plurality of redesigns, wherein each redesign includes a modification to at least one characteristic of the target item;
generating a plurality of variants, each variant including one of a plurality of locations and one of the plurality of redesigns;
inputting features representing each variant into an engagement prediction model to output a user engagement score indicating a predicted level of user engagement with the redesign of the target item at the location associated with the variant, wherein the engagement prediction model is a machine-learning model trained on historical data describing levels of user engagement with items across the plurality of locations;
selecting a set of candidate variants based on the user engagement scores; and
transmitting the selected set of candidate variants to a testing system, causing the testing system to conduct, for each candidate variant in the set, a test of the redesign corresponding to the candidate variant at the location corresponding to the candidate variant against a control group comprising the target item.
